(19) United States
(12) Patent Application Publication
(10) Pub. No.: US 2023/0249420 A1
(43) Pub. Date: Aug. 10, 2023

(54) METHOD OF PRODUCING FIBER-REINFORCED MOLDED ARTICLE

(71) Applicant: Toray Industries, Inc., Tokyo (JP)

(72) Inventors: Aki Takenaka, Nagoya-shi, Aichi (JP); Hideki Oka, Nagoya-shi, Aichi (JP); Fujio Kondo, Nagoya-shi, Aichi (JP)

(21) Appl. No.: 18/014,912

(22) PCT Filed: Jul. 19, 2021
(86) PCT No.: PCT/JP2021/026942

§ 371 Date: Jan. 6, 2023

(30) Foreign Application Priority Data
Jul. 27, 2020 (JP) 2020-126150

(51) Int. Cl. B29C 70/52

(52) U.S. Cl. CPC B29C 70/521; B29C 70/528

(57) ABSTRACT

A method of producing a fiber-reinforced molded article includes abrading a reinforcing fiber bundle to which a thermosetting resin composition is applied in a resin impregnation bath through a plurality of squeezers while applying tension to the bundle to impregnate the reinforcing fiber bundle with the thermosetting resin composition to provide a resin-impregnated fiber bundle and wring out excess thermosetting resin composition; and heat-curing the thermosetting resin composition while passing the fiber bundle through a mold to perform pultrusion molding into a predetermined shape, wherein a mold inlet cross-sectional shape of an insertion hole provided to the mold, the insertion hole being configured to allow insertion of the resin-impregnated fiber bundle, is similar to a cross-sectional shape of the fiber-reinforced molded article, the cross-sectional shapes being sections cut in a direction normal to a pultrusion direction; the squeezers each include a fiber inlet part and a fiber squeezing part.

### TECHNICAL FIELD

This disclosure relates to a method of producing a fiber-reinforced molded article by pultrusion molding.

### BACKGROUND

Fiber-reinforced resins composed of reinforcing fibers such as carbon fibers and glass fibers and thermosetting resins such as epoxy resins and phenol resins are lightweight but are superior in mechanical properties such as strength and rigidity as well as heat resistance and corrosion resistance and, therefore, they have been applied in many fields such as aerospace, automobiles, railway vehicles, ships, civil engineering, and sporting goods. Especially, in applications where high performance is required, fiber-reinforced resins using continuous reinforcing fibers are used. Carbon fibers with excellent specific strength and specific elastic modulus are often used as reinforcing fibers, and a thermosetting resin, especially an epoxy resin exhibiting excellent adhesion to carbon fibers, are often used as a matrix resin.

As a method of producing a fiber-reinforced resin, methods appropriately selected from among such methods as a prepreg process, a hand lay-up process, a filament winding process, a pultrusion molding (pultrusion) process, and a resin transfer molding (RTM) process have been used.

In pultrusion molding, a reinforcing fiber bundle in which several thousands to several tens of thousands of filaments are arranged in one direction is passed through a resin bath containing a liquid matrix resin to impregnate the reinforcing fiber bundle with the matrix resin. Then, in pultrusion molding, the reinforcing fiber bundle impregnated with the matrix resin is passed through a squeeze die and a heating mold and is continuously pultruded with a tensile machine, and simultaneously the matrix resin is cured. To perform pultrusion molding with high productivity, it is important to allow this step to proceed continuously and constantly. To smoothly pultrude a molded article having a smooth surface from the mold, it is necessary to hold the molded article in close contact with the mold until the resin impregnated into the reinforcing fiber bundle is sufficiently cured or to press it with an appropriate pressure.

However, when a fiber base material in which a reinforcing fiber bundle is impregnated with a thermosetting matrix resin is cured while being continuously pultruded in a pultrusion mold, that is, when the thermosetting matrix resin is cured to transition from a liquid state to a solid state, a resin residue called a “scale” may be generated by curing shrinkage of the thermosetting matrix resin and the resulting adhesion of a part of the thermosetting matrix resin remaining on the inner surface of the pultrusion mold. When this scale is generated, the pultrusion force may increase. Also, if the pultrusion molding is stopped midway and then the pultrusion molding is moved again, the scale will be ejected, but the stopped part of the fiber base material may differ in characteristics from other parts so that it may be difficult to perform continuous molding.

To suppress generation of scale, improvement of the pultrusion molding process, improvement of curing conditions in a mold, improvement of a thermosetting resin composition and the like have been performed.

Japanese Patent Laid-open Publication No. 1996-11222 discloses a device that produces a pultrusion-molded article 10 in which a reinforcing fiber composed of a continuous fiber bundle is impregnated with an uncured thermosetting resin in a resin impregnation bath 3 to provide an uncured-resin-impregnated reinforcing fiber and in which the uncured-resin-impregnated reinforcing fiber is shaped into a predetermined shape while passing through a pultrusion mold 6 and is cured and continuously pultruded, in which the resin impregnation bath 3 is disposed in close contact with a reinforcing fiber introduction side of the pultrusion mold 6, and an introduction guide for converging the continuous reinforcing fiber into substantially the same shape as the shape imparted by the mold is disposed immediately before the resin impregnation bath 3. It is also disclosed as the effects that since the resin impregnation bath and the mold are disposed in close contact with each other, a cavity that is formed when the product is pulled up from the conventional resin impregnation bath is not formed in the molded article, the pressure applied to the resin is normal pressure, the resin supply can be continuously performed, thus the molding of the pultrusion-molded article can be continuously performed, and the reinforcing fiber can be molded with about the same haul-off force as that of a production device that immerses the reinforcing fiber in the resin impregnation bath so that the pultruding force does not increase.

Further, Japanese Patent Laid-open Publication No. 2002-160303 discloses that all strengthening fibers are allowed to pass through a die having a shape substantially similar to the shape of the introduction port of the pultrusion passage of the mold so that the strengthening fibers are aligned parallel to each other, whereby the strengthening fibers can be introduced into the pultrusion passage substantially parallel to the axis of the pultrusion passage of the mold.

Japanese Patent Laid-open Publication No. 2009-66912 discloses a pultrusion molding method of molding a fiber-reinforced resin by inserting the fiber-reinforced resin into a heated pultrusion mold space and pultruding the fiber-reinforced resin while applying tension to a base material, in which by making an area of a cross section of the mold space perpendicular to a molding direction in a portion where a reaction rate of a thermosetting resin in the base material in the mold space is 50 to 80% larger than an area of a corresponding cross section in a base material inlet-side mold space, a pultrusion-molded article having excellent dimensional accuracy and high appearance quality can be produced with higher productivity at a higher molding speed.

Japanese Patent Laid-open Publication No. 2018-1682 discloses a method of producing a pultruded material obtained by impregnating reinforcing fibers with a thermosetting resin, in which the homogeneity of the thermosetting resin can be improved by incorporating into a pultrusion step an opening step of opening a bundle of the reinforcing fibers and a closing step of closing the bundle of the reinforcing fibers opened in the opening step by narrowing at least one of a width-direction length and a thickness-direction length under application of tension along a direction in which the reinforcing fibers extend.

However, it takes out a resin-impregnated fiber base material impregnated with a thermosetting resin composition into the air to prevent the thermosetting resin composition from falling from a reinforcing fiber bundle and forming voids. Therefore, in that configuration, it is difficult to suppress the formation of scales, which are the thermosetting resin composition that adheres to and remains on the inner surface of the mold because curing shrinkage, which occurs when the thermosetting resin composition in a liquid state is cured to transition to a solid state while being continuously pultruded, occurs in the middle of passing through the mold.

The method of JP '303 produces a thermoplastic resin composite material and aims to prevent fluffing of the composite material and yarn breakage of a reinforcing fiber bundle. For this reason, it has not been an object to produce a fiber-reinforced molded article obtained by heat-curing a resin-impregnated fiber base material impregnated with a thermosetting resin composition and pultrusion-molding the resin-impregnated fiber base material into a predetermined shape.

The method of JP '912 produces a pultrusion-molded article having excellent dimensional accuracy and high appearance quality with high productivity at a higher molding speed. However, the curing shrinkage occurring when the thermosetting matrix resin in a liquid state was cured to transition to a solid state while being continuously pultruded occurred also in a portion where the reaction rate of the thermosetting resin in the base material in the mold space was 50 to 80%. For this reason, it has been difficult to suppress the formation of scales, which are a part of the fiber-reinforced resin composition adhering to and remaining on the inner surface of the mold, and it has been difficult to avoid an increase in pultruding force in the production process.

The method of JP '682 improves homogeneity of the thermosetting resin. However, it has been difficult to suppress the formation of scales, which are a part of the fiber-reinforced resin composition adhering to and remaining on the inner surface of the mold, and it has been difficult to avoid an increase in pultruding force in the production process.

It could therefore be helpful to provide a method of producing a fiber-reinforced molded article capable of suppressing generation of a scale (resin residue) adhering to and remaining on an inner surface of a pultrusion mold in the production process of a fiber-reinforced molded article in pultrusion molding, avoiding an increase in pultruding force in the production process, and continuously performing pultrusion molding at a high speed.

### SUMMARY

We thus provide:

a method of producing a fiber-reinforced molded article obtained by abrading a reinforcing fiber bundle to which a thermosetting resin composition is applied in a resin impregnation bath through a plurality of squeezers while applying tension to the bundle to impregnate the reinforcing fiber bundle with the thermosetting resin composition to provide a resin-impregnated fiber bundle and to wring out an excess thermosetting resin composition and heat-curing the thermosetting resin composition while passing the fiber bundle through a mold to perform pultrusion molding into a predetermined shape, in which a mold inlet cross-sectional shape of an insertion hole provided to the mold, the insertion hole being configured to allow insertion of the resin-impregnated fiber bundle, is similar to a cross-sectional shape of the fiber-reinforced molded article, the cross-sectional shapes being sections cut in a direction normal to a pultrusion direction; the squeezers each include a fiber inlet part and a fiber squeezing part; a cross-sectional shape of the fiber squeezing part is similar to the mold inlet cross-sectional shape of the mold or has a planar shape drawn by points a fixed distance outwardly away from an outline of the mold inlet cross-sectional shape of the mold; S₂ and S_{D} satisfy Formula (1), where S₂ (mm²) is a cross-sectional area of a cross-sectional shape of a fiber squeezing part side of the squeezer, and S_{D} (mm²) is a cross-sectional area of the mold inlet cross-sectional shape of the mold; and the plurality of squeezers are disposed at intervals along a passage for the reinforcing fiber bundle between the resin impregnation bath and the mold:

0.8≤S₂/S_{D}≤3 (1).

It is preferable that the squeezer include a fiber inlet part having a tapered surface and a fiber squeezing part connected to the fiber inlet part, an inlet-side cross-sectional shape and an outlet-side cross-sectional shape of the fiber squeezing part be the same, S₁ and the S₂ satisfy Formula (2) where S₁ (mm²) is a cross-sectional area on a fiber supply side of the fiber inlet part, and Formula (3) be satisfied where θ is an inclination angle of the tapered surface of the fiber inlet part with respect to a central axis of the fiber inlet part:

1.2≤S₁/S₂≤100 (2)

30°≤θ≤75° (3).

It is preferable that an excessive amount of the thermosetting resin contained in the resin-impregnated fiber bundle be wrung out at the fiber squeezing part of each of the squeezers in the process of passage through the plurality of squeezers disposed at intervals.

It is preferable to further dispose, as the plurality of squeezers disposed at intervals, a squeezer having a cross-sectional shape of the fiber squeezing part obtained by combining an outline having a shape similar to the mold inlet cross-sectional shape with a planar shape drawn by points a fixed distance outwardly away from at least a part of the outline.

It is preferable that a cross-sectional area of a cross-sectional shape of the fiber squeezing part of an arbitrary squeezer among the plurality of squeezers disposed at intervals be equal to or larger than a cross-sectional area of a cross-sectional shape of the fiber squeezing part of a squeezer disposed downstream of the arbitrary squeezer.

It is thus possible to suppress the occurrence of curing shrinkage that occurs when the thermosetting resin composition in a liquid state is cured to transition to a solid state, it is possible to suppress formation of scale adhering to and remaining on the inner surface of the pultrusion mold, and it is possible to continuously realize high-speed pultrusion molding.

### BRIEF DESCRIPTION OF THE DRAWINGS

FIG. 1 is a schematic view of a pultrusion molding machine used in our method of producing a molded article.

FIGS. 2(a)—(c) are cross-sectional views showing a process in which scales are formed from a gelled state of a thermosetting resin composition in a conventional pultrusion mold.

FIG. 3 is sectional side view of a plurality of squeezers and a mold inlet used in our method of producing a molded article, where a section cut in a tangential direction with respect to the pultrusion direction is defined as a sectional side view.

FIG. 4 is sectional side shape view of one arbitrary squeezer among the squeezers used in our method of producing a molded article, where a section cut in a tangential direction with respect to the pultrusion direction is defined as a sectional side shape.

FIGS. 5(a)—(c) are schematic cross-sectional views showing a cross-sectional shape of a mold inlet part and a cross-sectional shape of a fiber squeezing part of each squeezer.

FIGS. 6(a)—(c) are schematic cross-sectional views showing a cross-sectional shape of a fiber squeezing part of a squeezer different from FIGS. 5(a)—(c).

### DESCRIPTION OF REFERENCE SIGNS

1: Pultrusion molding process
2: Strengthening fiber bundle
3: Creel
4: Resin impregnation bath
5: Squeezer
5a to 5d: Squeezer
6: Pultrusion mold
7: Resin-impregnated fiber base material
8: Winder
9: After-cure furnace
10: Puller
11: Gelled matrix resin
12: Surface layer part where matrix resin is transitioning to cured state
13: State where matrix resin has been cured to inside and curing shrinkage occurred
14: Scale
15: Fiber inlet part of squeezer
16: Fiber squeezing part of squeezer
17: Cross-sectional shape of mold inlet part
18: Cross-sectional shape of fiber squeezing part similar to cross-sectional shape 17 of mold inlet part
19: Cross-sectional shape of fiber squeezing part drawn by points fixed distance away from outline of cross-sectional shape 17 of mold inlet part
20: Cross-sectional shape of mold inlet part
21: Cross-sectional shape of fiber squeezing part of squeezer
22: Cross-sectional shape of fiber squeezing part of squeezer

### DETAILED DESCRIPTION

Hereinafter, an example will be described with reference to the drawings. This disclosure is not limited to either the drawings nor working examples.

We provide a method of producing a fiber-reinforced molded article obtained by abrading a reinforcing fiber bundle to which a thermosetting resin composition is applied in a resin impregnation bath through a plurality of squeezers while applying tension to the bundle to impregnate the reinforcing fiber bundle with the thermosetting resin composition to provide a resin-impregnated fiber bundle and to wring out an excess thermosetting resin composition and heat-curing the thermosetting resin composition while passing the fiber bundle through a mold to perform pultrusion molding into a predetermined shape, in which a mold inlet cross-sectional shape of an insertion hole provided to the mold, the insertion hole being configured to allow insertion of the resin-impregnated fiber bundle, is similar to a cross-sectional shape of the fiber-reinforced molded article, the cross-sectional shapes being sections cut in a direction normal to a pultrusion direction; the squeezers each include a fiber inlet part and a fiber squeezing part; a cross-sectional shape of the fiber squeezing part is similar to the mold inlet cross-sectional shape of the mold or has a planar shape drawn by points a fixed distance outwardly away from an outline of the mold inlet cross-sectional shape of the mold; S₂ and S_{D} satisfy Formula (1), where S₂ (mm²) is a cross-sectional area of a cross-sectional shape of a fiber squeezing part side of the squeezer, and S_{D} (mm²) is a cross-sectional area of the mold inlet cross-sectional shape of the mold; and the plurality of squeezers are disposed at intervals along a passage for the reinforcing fiber bundle between the resin impregnation bath and the mold:

0.8≤S₂/S_{D}≤3 (1).

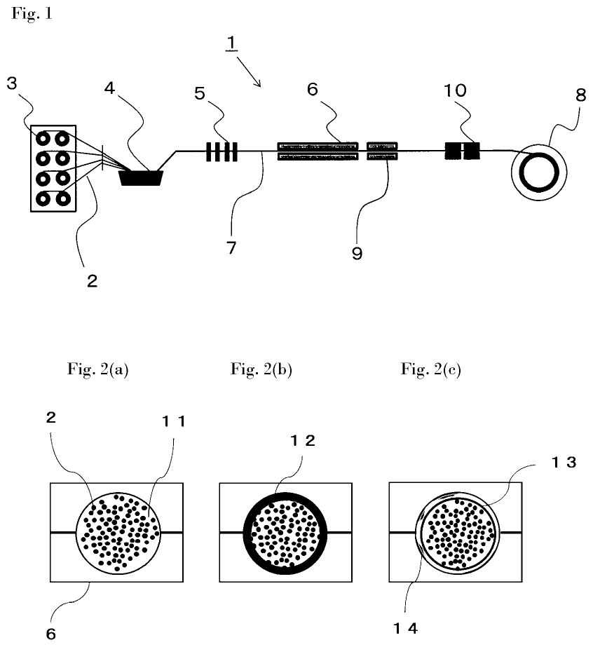

FIG. 1 shows a schematic view of a production device used in our method of producing a fiber-reinforced molded article. As shown in FIG. 1, in a pultrusion molding process 1, strengthening fiber bundles 2 are pulled out from a creel 3, the strengthening fiber bundles 2 are introduced into a resin impregnation bath 4 via a guide roll, provided with a thermosetting resin composition, and abraded through squeezers 5 to impregnate the strengthening fiber bundles 2 with the thermosetting resin composition and to remove an excessive part of the thermosetting resin composition. The resin excessively impregnated into the strengthening fiber bundles 2 flows back from the squeezers 5 and drips down from the squeezer inlets to be removed. Furthermore, by determining the positions of the strengthening fiber bundles 2 one by one with a guide (not illustrated), a resin-impregnated fiber base material 7 having a desired cross-sectional shape can be obtained, and the resin-impregnated fiber base material 7 can be made to enter a pultrusion mold 6, which is the next step, in a balanced manner.

The resin-impregnated fiber base material 7 impregnated with the thermosetting resin composition is heated while passing in the pultrusion mold 6 and, after the thermosetting resin composition is cured, is introduced into an after-cure furnace 9 and further heated and cured in the furnace. Thereafter, the fiber-reinforced molded article is drawn out from the after-cure furnace 9 by driving of a puller 10 and then wound up by a winder 8.

The process in which the resin-impregnated fiber base material 7 is cured in the pultrusion mold 6 will be described in detail. FIGS. 2(a)—(c) show cross-sectional views of the pultrusion mold 6 when cut in the direction normal to the pultrusion direction of the resin-impregnated fiber base material 7. The resin-impregnated fiber base material 7 is introduced from the mold inlet of the pultrusion mold 6 and partially starts to gel due to heating by the pultrusion mold 6 while being conveyed at a constant pultruding speed in the pultrusion mold 6 heated to a constant temperature. FIG. 2(a) shows a state in which the thermosetting resin composition of the resin-impregnated fiber base material 7 has gelled at an initial stage of gelation. After that, the curing proceeds, and FIG. 2(b) shows the latter half stage of gelation, in which the thermosetting resin composition is transitioning to a cured state in the surface layer of the resin-impregnated fiber base material 7.

If the excess resin has not been sufficiently removed in this cured state, the resin-impregnated fiber base material 7 cannot hold the thermosetting resin composition, and a part of the resin component is likely to be left in the mold. Curing of the remaining curable resin composition proceeds, and the remaining curable resin composition is not peeled off from the inner surface of the pultrusion mold but adheres and remains. As a result, as shown in FIG. 2(c), in a state 13 in which the curing of the thermosetting resin composition has proceeded to the inside of the resin-impregnated fiber base material 7 in which curing shrinkage has occurred, the remaining curable resin composition is deposited as a resin residue called a scale 14, which causes a scratch mark on the surface layer of the molded article and an increase in pultruding force in the production process to cause yarn breakage.

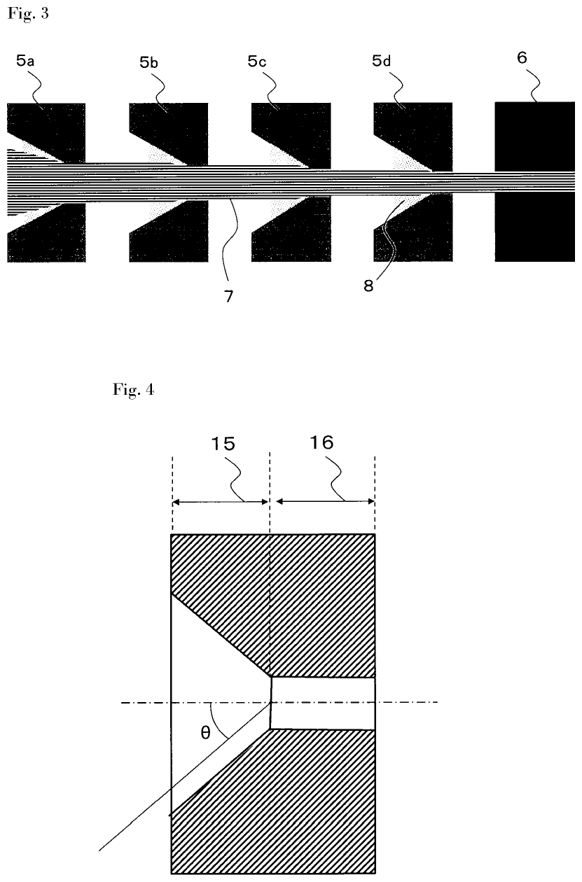

On the other hand, in our method suitable for molding the fiber-reinforced molded article, as shown in FIG. 3, a plurality of squeezers 5 are disposed between the resin impregnation bath and the mold inlet, and the respective squeezers 5a to 5d are disposed at intervals so that the excess resin of the resin-impregnated fiber base material 7 can be efficiently removed.

The number of squeezers 5 to be used depends on the shape of the molded article and the number of filaments constituting the fiber bundle but is preferably two or more, more preferably three or more.

Next, specific shapes of the squeezers 5 will be described. FIG. 4 is a sectional side view of an arbitrary one of the squeezers 5 arranged when a section cut in a tangential direction with respect to the pultrusion direction is taken as a side section. It is important that the squeezer 5 is constituted of a fiber inlet part 15 and a fiber squeezing part 16 and that the cross-sectional shape of the fiber squeezing part 16 is similar to the mold inlet cross-sectional shape of the mold or has a planar shape drawn by points a fixed distance away from the outline of the mold inlet cross-sectional shape of the mold.

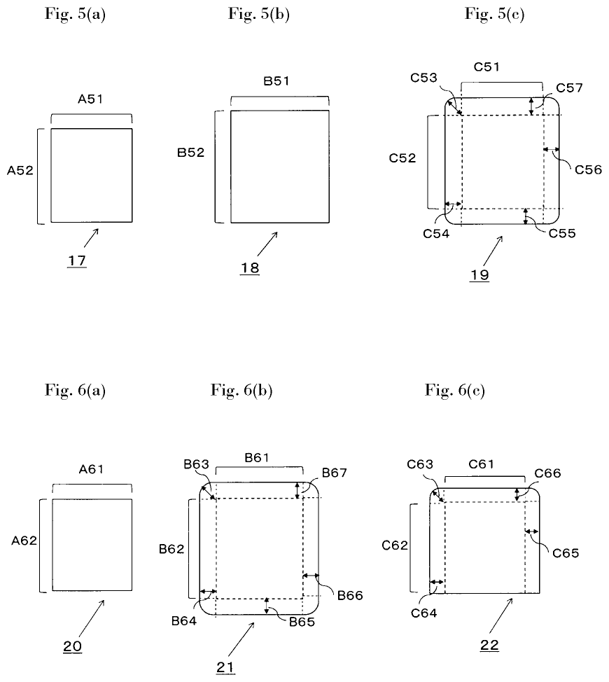

An example of the cross-sectional shape of the mold inlet part and the cross-sectional shape of the fiber squeezing part 16 of the squeezer when the cross-sectional shape of the molded article is a quadrangular shape will be described with reference to FIGS. 5(a)— (c). FIG. 5(b) shows an example of a cross-sectional shape 18 of the fiber squeezing part having a shape similar to a cross-sectional shape 17 of the mold inlet part with respect to the cross-sectional shape 17 of the mold inlet part shown in FIG. 5(a). The ratio A51/A52 of the sides of the quadrangle of each of the cross-sectional shape 18 of the fiber squeezing part and the cross-sectional shape 17 of the mold inlet part is equal to the ratio B51/B52 of the sides of the quadrangle of the fiber squeezing part in FIG. 5(b), and the cross-sectional shapes are similar shapes. FIG. 5(c) shows an example of a cross-sectional shape 19 of the fiber squeezing part drawn by points a fixed distance away from the outline of the cross-sectional shape 17 of the mold inlet part. In this example, the lengths (A51 and A52) of the respective sides of the quadrangle of the cross-sectional shape 17 of the mold inlet part illustrated in FIG. 5(a) are the same as the lengths of the straight portions (the straight portions separated from the outline of the cross-sectional shape 17 of the mold inlet part by fixed distances C54 to C57) C51 and C52 illustrated in FIG. 5(c), and the adjacent straight portions are connected by arcs having the same length C53 as C54 to C57 as a radius. As a result, the shape obtained in FIG. 5(c) is the shape drawn by points a fixed distance away from the outline of the cross-sectional shape 17 of the mold inlet part shown in FIG. 5(a).

In addition, the squeezer 5 preferably includes a fiber inlet part 15 having a tapered surface and a fiber squeezing part 16 connected to the fiber inlet part 15.

When an inclination angle of the tapered surface of the fiber inlet part 15 with respect to the central axis of the fiber inlet part 15 is θ, the inclination angle θ is preferably 30° or more and 75° or less. When the inclination angle θ is 30° or more and 75° or less, the tapered surface provided in the fiber inlet part 15 can squeeze the excess resin without excess or deficiency without retaining the excess resin around the fiber squeezing part 16.

Furthermore, it is preferable that the inlet cross-sectional shape of the fiber squeezing part 16 and the outlet cross-sectional shape of the fiber squeezing part 16 be the same and that the ratio S₁/S₂ of the cross-sectional area S₁ (mm²) of the fiber inlet part 15 on the fiber supply side to the cross-sectional area S₂ (mm²) of the fiber squeezing part 16 be 1.2 times or more and 100 times or less. When the inlet cross-sectional shape of the fiber squeezing part 16 and the outlet cross-sectional shape of the fiber squeezing part 16 are the same, the excess resin can be wrung with a small haul-off force. When the ratio S₁/S₂ is in the above preferred range, the excess resin contained in the resin-impregnated fiber bundle is easily discharged from the squeezer, and on the other hand, the squeezer dimension is moderate so that the production is easy, and the production cost can be suppressed.

Furthermore, the corner of the connecting portion between the fiber inlet part 15 and the fiber squeezing part 16 is preferably rounded (curved surface) by 0.1 times or more and 50 times or less the thickness of the molded article (the thickness from the outermost surface to the hollow portion in a hollow article). By providing the roundness, the resin-impregnated fiber base material is aligned, and the excess resin is discharged so that unnecessary abrasion is reduced when the fiber bundle is compressed, and the occurrence of fuzz can be expected to be suppressed.

It is also preferable to use, as the squeezers disposed at intervals, a squeezer having a cross-sectional shape of the fiber squeezing part obtained by combining an outline having a shape similar to the mold inlet cross-sectional shape with a planar shape drawn by points a fixed distance outwardly away from at least a part of the outline.

FIGS. 6(a)—(c) illustrate an example of a cross-sectional shape of the squeezer. With respect to a cross-sectional shape 20 of the mold inlet part illustrated in FIG. 6(a), a cross-sectional shape 21 of a resin squeezing part of the squeezer illustrated in FIG. 6(b) is obtained by connecting straight line portions B61 and B62 fixed distances B64 to B67 away from an outline, which is a shape similar to the cross-sectional shape 20 of the mold inlet part illustrated in FIG. 6(a), to adjacent straight line portions B61 and B62 via arcs having a radius of the same length B63 as the lengths B64 to B67. The ratio A61/A62 of the lengths of respective sides of the quadrangle of the cross-sectional shape 20 of the mold inlet part in FIG. 6(a) is equal to the ratio B61/B62 of the lengths of the straight line portions away from the outline in FIG. 6(b) by fixed distances B64 to B67. With such a shape, the excess resin is less likely to be retained at the corner portion, and the continuous passability of the resin-impregnated fiber base material can be improved.

As another shape, in a cross-sectional shape 22 of the resin squeezing part of the squeezer as shown in FIG. 6(c), a shape similar to the cross-sectional shape 20 of the mold inlet part in FIG. 6(a) is regarded as the outline, and straight line portions C61 and C62 away from three sides that are a part of the outline by fixed distances C64 to C66 and adjacent straight line portions C61 and C62 are connected via arcs having a radius of the same length C63 as the lengths C64 to C66. The ends of the remaining side (the lower side in FIG. 6(c)) of the outline are extended and connected to the straight line portions away from the outline by fixed distances C64 to C66 so that the cross-sectional shape 22 of the fiber squeezing part of the squeezer can be provided.

Furthermore, it is also preferable that the squeezers disposed at intervals be a combin-ation of a squeezer including a fiber squeezing part similar to the mold inlet cross-sectional shape of the mold and a squeezer including a fiber squeezing part having a planar shape drawn by points a fixed distance outwardly away from the outline of the mold inlet cross-sectional shape of the mold or a squeezer having a cross-sectional shape of a fiber squeezing part obtained by combining an outline having a shape similar to the mold inlet cross-sectional shape and a planar shape drawn by points a fixed distance outwardly away from at least a part of the outline.

It is also preferable that a cross-sectional area of a cross-sectional shape of the fiber squeezing part 16 of an arbitrary squeezer among the squeezers disposed at intervals be equal to or larger than a cross-sectional area of a cross-sectional shape of the fiber squeezing part 16 of a squeezer disposed downstream of the arbitrary squeezer. By arranging the squeezers at intervals to satisfy such a relationship, it is possible to dispose the squeezers such that the cross-sectional areas of the fiber squeezing parts 16 of the squeezers gradually decrease from the upstream side to the downstream side. With such an arrangement, when passing from an arbitrary squeezer to the next squeezer on the mold side (downstream side), unnecessary abrasion is reduced when the excess resin failed to be removed by the arbitrary squeezer is discharged by the fiber squeezing part of the next squeezer on the mold side (downstream side), and the occurrence of fuzz can be expected to be suppressed.

The cross-sectional shapes of the fiber squeezing parts 16 of the squeezers have cross-sectional areas 0.8 times or more and 3 times or less as large as the area of the inlet cross-sectional shape of the mold. If it is less than 0.8 times, the impregnation of the resin into the fiber bundle becomes insufficient, and if it is more than 3 times, it becomes difficult to remove the excess resin excessively impregnated into the fiber bundle.

The arithmetic average roughness (Ra) of the surface of the fiber squeezing part 16 is preferably 0.05 or more and 2.00 or less. When the arithmetic average roughness (Ra) of the surface of the fiber squeezing part 16 falls within the above preferable range, it is easy to produce the squeezer and it is possible to suppress the production cost, and on the other hand, unnecessary abrasion is reduced when squeezing the excess resin of the resin-impregnated fiber base material by the squeezer so that it can be expected to suppress generation of fuzz. The arithmetic average roughness (Ra) referred to herein indicates the arithmetic average roughness of the cross-sectional curve in JIS B 0601-2003 and is measured by a measurement method using a stylus type surface roughness tester in JIS B 0633-2001.

The fiber volume fraction (Vf) of the strengthening fiber bundle is preferably 50% or more and 80% or less. When the fiber volume fraction (Vf) of the strengthening fiber bundle is within the above preferable range, the thermosetting resin composition impregnated into the resin-impregnated fiber base material is not discharged as an excess resin more than necessary by the squeezer, and on the other hand, the amount of the thermosetting resin impregnated into the strengthening fiber bundle 2 becomes appropriate so that the strengthening fiber bundle 2 is less likely to be directly abraded on the squeezer, and it is possible to effectively prevent the increase in pultruding force and the occurrence of fluffing.

The thermosetting resin composition is preferably a resin composition containing at least components [A] to [D]:
Component [A]: Epoxy resin,
Component [B]: Curing agent,
Component [C]: Filler containing at least one selected from inorganic carbon, silicon, magnesium, calcium, and aluminum as a component and having a Mohs hardness of 3 or less, and
Component [D]: Internal release agent.

The “epoxy resin” refers to a compound having two or more epoxy groups in one molecule.

For the resin composition, a filler containing at least one selected from inorganic carbon, silicon, magnesium, calcium, and aluminum as a component and having a Mohs hardness of 3 or less is preferably used as the component [C]. In this example, since the filler enters between the carbon fibers of the resin-impregnated fiber base material 7, an effect of suppressing curing shrinkage is obtained when the resin composition is cured. When the Mohs hardness is adjusted to 3 or less, the filler is soft, the influence on the mold is small, and the damage to a mold can be reduced. Examples of the filler having a Mohs hardness of 3 or less include calcium carbonate, aluminum hydroxide, talc, and carbon black.

In an epoxy resin composition, a curing catalyst (component [E]) may be used. The component [E] is not particularly limited as long as it accelerates the chemical reaction between an epoxy resin and a curing agent.

Preferred examples of the reinforcing fiber for the resin-impregnated fiber base material 7 include glass fiber, aramid fiber, polyethylene fiber, silicon carbide fiber, and carbon fiber.

Our methods can be applied to molding of fiber-reinforced molded articles having various shapes as long as the molded articles have fixed cross-sectional shapes, and examples thereof include cylindrical rod-shaped molded articles, various cross-sectional molded articles having a C-shaped cross section, a T-shaped cross section, an I-shaped cross section, an L-shaped cross section, and the like, rod-shaped molded articles having a polygonal cross section, sheet-shaped thin molded articles, thick molded articles having a rectangular cross section, and these may be hollow. Although not limited, it is preferable that the molded article have a thickness (the thickness measured from the outermost surface to the hollow portion in a hollow article) of 20 mm or less, particularly the molded article be a cylindrical rod-shaped molded article having a diameter of 1.0 to 10.0 mm, from the viewpoint of dimensional stability because sudden curing shrinkage due to heat storage inside the molded article is suppressed and the dimension is often stable.

### EXAMPLES

Next, our methods will be described with reference to working examples, but this disclosure is not limited to the working examples.

### (1) Preparation of Thermosetting Resin Composition

To obtain a pultrusion fiber-reinforced molded article of each working example, the following components [A] to [E] were mixed at room temperature to provide a resin composition:
Component [A]: Bisphenol F epoxy (“EPICLON” (registered trademark) 830 (manufactured by DIC Corporation) as an epoxy resin
Component [B]: Methyl nadic anhydride “KAYAHARD” (registered trademark) MCD (manufactured by Nippon Kayaku Co., Ltd.) as a curing agent
Component [C]: Talc “Micron White” (registered trademark) #5000S (average particle diameter: 4.75 Mohs hardness: 1, manufactured by Hayashi Kasei Co., Ltd.) as a filler
Component [D]: Oleic acid ester “Chemlease” (registered trademark) IC-35 (manufactured by Chem-Trend L.P.) as an internal release agent
Component [E]: 2-Ethyl-4-methylimidazole “CUREZOL” (registered trademark) 2E4MZ (manufactured by Shikoku Chemicals Corporation) as a cure accelerator.

### (2) Production of Pultrusion-Molded Article

Molding was performed using the pultrusion molding process shown in FIG. 1. The squeezers shown in FIG. 3 were used as the squeezers 5 in FIG. 1.

“Torayca” (registered trademark) T700SC-24K (carbon fiber, manufactured by Toray Industries, Inc.) was used as the strengthening fiber bundle 2. The prepared resin composition was charged into the resin impregnation bath 4 at 25° C., the carbon fiber as the strengthening fiber bundle 2 was caused to pass through the resin impregnation bath 4 containing the resin composition to impregnate the carbon fiber with the resin, then the strengthening fiber bundle 2 was abraded through the squeezers 5 to be impregnated with the thermosetting resin composition and to partially remove an excessive thermosetting resin composition, and then the resin-impregnated fiber base material 7 was introduced into a mold inlet. At the time of this introduction, the thermosetting resin composition was in a liquid state. The resin-impregnated fiber base material 7 discharged from the mold outlet was introduced into the after-cure furnace 9 and was further heat-cured in the furnace to mold a pultrusion-molded article.

The molding conditions are shown in Table 1. As the mold, one with a cavity having a perfect circular cross section of 2.0 mm in diameter and having a surface provided with hard chromium plating was used unless otherwise noted. As the squeezers, squeezers having cavities with perfect circular cross sections having diameters shown in Table 1 were used, and one to four squeezers were disposed between the outlet of the resin impregnation bath and the mold inlet at intervals of 5 cm depending on the conditions.

The after-curing was performed at 270° C. As a result of molding, a pultrusion-molded article having a diameter of 2.0 mm and a Vf (fiber volume content) of about 70% was obtained.

As molding conditions, in working examples other than Example 2 and all comparative examples, pultrusion molding was performed at a mold temperature Tp of 190° C., a mold passage length of 0.6 m, and a molding speed of 0.75 m/min. In Example 2, pultrusion molding was performed at a mold temperature Tp of 195° C., a mold passage length of 0.6 m, and a molding speed of 1.0 m/min.

### (3) Post-Mold Deformation

After a molded article was pulled out from the mold, one successfully molded without deformation was judged as “good,” one that deformed but was suppressed to a diameter within ±5% of the cavity diameter of the mold was judged as “fair,” and one greatly deformed, for example, expanded, more than the above criterion was judged as “bad.”

### (4) Molding Distance

The molding distance of the molded article was measured using a total length meter. The measurement was started immediately after the molded article was led out from the mold, and the molding length measured when a defect of the product was confirmed or when a stop of the device due to yarn breakage occurred was recorded with the maximum being 5,000 m.

TABLE 1

| | | | | | | | Comparative | Comparative | Comparative | Comparative |
|---|---|---|---|---|---|---|---|---|---|---|
| | | | Example 1 | Example 2 | Example 3 | Example 4 | Example 1 | Example 2 | Example 3 | Example 4 |
| Pultrusion | Mold Temperature Tp (° C.) | | 190 | 195 | 190 | 190 | 190 | 190 | 190 | 190 |
| Molding | Mold Inlet Part Diameter (mm) | | 2.0 | 2.0 | 2.0 | 2.0 | 2.0 | 2.0 | 2.0 | 2.0 |
| Conditions | Mold Passage Length (m) | | 0.6 | 0.6 | 0.6 | 0.6 | 0.6 | 0.6 | 0.6 | 0.6 |
| | Molding Speed (m/min) | | 0.75 | 1.0 | 0.75 | 0.75 | 0.75 | 0.75 | 0.75 | 0.75 |
| Squeezer | Squeezer | Fiber Inlet Part | 15 | 15 | 15 | 15 | 15 | 4.0 | 15 | 15 |
| Conditions | a | Diameter (mm) | | | | | | | | |
| | | Fiber Squeezing | 3.0 | 3.4 | 3.0 | 3.0 | 2.0 | 4.0 | 3.0 | 4.0 |
| | | Part Diameter (mm) | | | | | | | | |
| | | θ (°) | 40 | 40 | 70 | 40 | 40 | 0 | 40 | 40 |
| | | S₂/S_{D} | 2.25 | 2.89 | 2.25 | 2.25 | 1.0 | 4.00 | 2.25 | 4.00 |
| | | S₁/S₂ | 25 | 19.5 | 25 | 25 | 56.3 | 1.0 | 25 | 14 |
| | Squeezer | Fiber Inlet | 15 | 15 | 15 | 15 | — | 2.2 | 15 | 15 |
| | b | Diameter (mm) | | | | | | | | |
| | | Fiber Squeezing | 2.2 | 3.0 | 2.2 | 2.2 | — | 2.2 | 2.2 | 2.0 |
| | | Part Diameter (mm) | | | | | | | | |
| | | θ (°) | 40 | 40 | 70 | 40 | — | 0 | 40 | 40 |
| | | S₂/S_{D} | 1.21 | 2.25 | 1.21 | 1.21 | — | 1.21 | 1.21 | 1.0 |
| | | S₁/S₂ | 46.5 | 25 | 46.5 | 46.5 | — | 1.0 | 46.5 | 56.3 |
| | Squeezer | Fiber Inlet | 15 | 15 | 15 | 15 | — | 2.1 | 15 | — |
| | c | Diameter (mm) | | | | | | | | |
| | | Fiber Squeezing | 2.1 | 2.5 | 2.1 | 2.1 | — | 2.1 | 2.1 | — |
| | | Part Diameter (mm) | | | | | | | | |
| | | θ (°) | 40 | 40 | 70 | 40 | — | 0 | 40 | — |
| | | S₂/S_{D} | 1.10 | 1.56 | 1.10 | 1.10 | — | 1.10 | 1.10 | — |
| | | S₁/S₂ | 51.0 | 36 | 51.0 | 51.0 | — | 1.0 | 51.0 | — |
| | Squeezer | Fiber Inlet | 15 | 15 | 15 | 15 | — | 2.0 | 15 | — |
| | d | Diameter (mm) | | | | | | | | |
| | | Fiber Squeezing | 2.0 | 2.0 | 2.0 | 1.9 | — | 2.0 | 1.4 | — |
| | | Part Diameter (mm) | | | | | | | | |
| | | θ (°) | 40 | 40 | 70 | 40 | — | 0 | 40 | — |
| | | S₂/S_{D} | 1.0 | 1.0 | 1.0 | 0.90 | — | 1.0 | 0.49 | — |
| | | S₁/S₂ | 56.3 | 56.3 | 56.3 | 62.3 | — | 1.0 | 115 | — |

| | | | | | | | | |
|---|---|---|---|---|---|---|---|---|
| Post-mold Deformation | good | good | good | good | good | good | fair | good |
| Molding Distance (m) | 5,000 | 5,000 | 5,000 | 5,000 | 200 | 500 | — | 200 |

### Example 1

Using the device shown in FIG. 1, molding was performed using the above resin composition under the molding conditions and squeezer conditions shown in Table 1. The molded article discharged from the mold was not deformed, and no yarn breakage or stop of the device was observed even at a molding distance of 5,000 m.

### Example 2

Using the device shown in FIG. 1, molding was performed using the above resin composition under the molding conditions and squeezer conditions shown in Table 1. The molded article discharged from the mold was not deformed, and no yarn breakage or stop of the device was observed even at a molding distance of 5,000 m.

### Example 3

Using the device shown in FIG. 1, molding was performed using the above resin composition under the molding conditions and squeezer conditions shown in Table 1. The molded article discharged from the mold was not deformed, and no yarn breakage or stop of the device was observed even at a molding distance of 5,000 m.

### Example 4

Using the device shown in FIG. 1, molding was performed using the above resin composition under the molding conditions and squeezer conditions shown in Table 1. The molded article discharged from the mold was not deformed, and no yarn breakage or stop of the device was observed even at a molding distance of 5,000 m.

### Comparative Example 1

Using the device shown in FIG. 1, molding was performed using the above resin composition under the molding conditions and squeezer conditions shown in Table 1. That is, only one squeezer a was used as the squeezer. Deformation of the molded article discharged from the mold was not observed, but yarn breakage was observed at a molding distance of 200 m.

### Comparative Example 2

Using the device shown in FIG. 1, molding was performed using the above resin composition under the molding conditions and squeezer conditions shown in Table 1. That is, four squeezers a to d were used as the squeezers, but S₂/S_{D} of the squeezer a was 4.00, which did not satisfy Formula (1). Deformation of the molded article discharged from the mold was not observed, but yarn breakage was observed at a molding distance of 500 m.

### Comparative Example 3

Using the device shown in FIG. 1, molding was performed using the above resin composition under the molding conditions and squeezer conditions shown in Table 1. That is, four squeezers a to d were used as the squeezers, but S₂/S_{D} of the squeezer d was 0.49, which did not satisfy Formula (1). Although the diameter of the molded article discharged from the mold was within ±5% of the cavity diameter of the mold, fluffing was observed, and yarn breakage occurred immediately after molding.

### Comparative Example 4

Using the device shown in FIG. 1, molding was performed using the above resin composition under the molding conditions and squeezer conditions shown in Table 1. That is, two squeezers a and b were used as the squeezers, but S₂/S_{D} of the squeezer a was 4.00, which did not satisfy Formula (1). Deformation of the molded article discharged from the mold was not observed, but yarn breakage was observed at a molding distance of 200 m.

### INDUSTRIAL APPLICABILITY

Our production method can effectively provide a pultrusion fiber-reinforced molded article used for wind turbine blades, building repair and reinforcement members, electric/electronic device housings, bicycles, automobile members, structural materials for sporting-goods, aircraft interior materials, transportation boxes, and the like.

1-5. (canceled)

6. A method of producing a fiber-reinforced molded article comprising:
abrading a reinforcing fiber bundle to which a thermosetting resin composition is applied in a resin impregnation bath through a plurality of squeezers while applying tension to the bundle to impregnate the reinforcing fiber bundle with the thermosetting resin composition to provide a resin-impregnated fiber bundle and wring out excess thermosetting resin composition; and
heat-curing the thermosetting resin composition while passing the fiber bundle through a mold to perform pultrusion molding into a predetermined shape,
wherein a mold inlet cross-sectional shape of an insertion hole provided to the mold, the insertion hole being configured to allow insertion of the resin-impregnated fiber bundle, is similar to a cross-sectional shape of the fiber-reinforced molded article, the cross-sectional shapes being sections cut in a direction normal to a pultrusion direction; the squeezers each include a fiber inlet part and a fiber squeezing part,
a cross-sectional shape of the fiber squeezing part is similar to the mold inlet cross-sectional shape of the mold or has a planar shape drawn by points a fixed distance outwardly away from an outline of the mold inlet cross-sectional shape of the mold,
S₂ and S_{D} satisfy Formula (1), where S₂ (mm²) is a cross-sectional area of a cross-sectional shape of a fiber squeezing part side of the squeezer, and S_{D} (mm²) is a cross-sectional area of the mold inlet cross-sectional shape of the mold, and
the plurality of squeezers are disposed at intervals along a passage for the reinforcing fiber bundle between the resin impregnation bath and the mold:
0.8≤S₂/S_{D}≤3 (1).

7. The method according to claim 6,
wherein the squeezer includes a fiber inlet part having a tapered surface and a fiber squeezing part connected to the fiber inlet part,
an inlet-side cross-sectional shape and an outlet-side cross-sectional shape of the fiber squeezing part are the same,
S₁ and the S₂ satisfy Formula (2) where S₁ (mm²) is a cross-sectional area on a fiber supply side of the fiber inlet part, and
Formula (3) is satisfied where θ is an inclination angle of the tapered surface of the fiber inlet part with respect to a central axis of the fiber inlet part:
1.2≤S₁/S₂≤100 (2)
30°≤θ≤75° (3).

8. The method according to claim 6, wherein an excessive amount of the thermosetting resin contained in the resin-impregnated fiber bundle is wrung out at the fiber squeezing part of each of the squeezers in the process of passage through the plurality of squeezers disposed at intervals.

9. The method according to claim 6, wherein, as the plurality of squeezers disposed at intervals, a squeezer having a cross-sectional shape of the fiber squeezing part obtained by combining an outline having a shape similar to the mold inlet cross-sectional shape with a planar shape drawn by points a fixed distance outwardly away from at least a part of the outline is further disposed.

10. The method according to claim 6, wherein a cross-sectional area of a cross-sectional shape of the fiber squeezing part of an arbitrary squeezer among the plurality of squeezers disposed at intervals is equal to or larger than a cross-sectional area of a cross-sectional shape of the fiber squeezing part of a squeezer disposed downstream of the arbitrary squeezer.
